(19) United States
(12) Patent Application Publication
(10) Pub. No.: US 2008/0316033 A1
(43) Pub. Date: Dec. 25, 2008

(54) Apparatus for Protecting a Rfid Password and Method Therefor, and Rfid Tag Accessing Method

(76) Inventors: Sang-Keun Yoo, Chungcheongnam-do (KR); Jun-seob Lee, Daejeon-city (KR); Yong-woon Kim, Chungcheongnam-do (KR); Hyoung-jun Kim, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 12/161,270

(22) PCT Filed: Oct. 27, 2006
(86) PCT No.: PCT/KR06/04410

§ 371 Date: Jul. 17, 2008

(30) Foreign Application Priority Data
Feb. 24, 2006 (KR) 10-2006-0018438

(51) Int. Cl. G08B 13/14; B05D 1/36

(52) U.S. Cl. 340/572.1; 427/258

(57) ABSTRACT

An apparatus and method of protecting an RFID password, and an RFID tag access method are provided. The apparatus for protecting an RFID password comprises a recording medium on which the password for the RFID tag is printed, and a disposable shielding member that can be removed physically or chemically, formed on the surface of the recording medium to visually shield the password. Accordingly, the RFID password can be provided securely to a user, and the user can access the RFID tag using the RFID password.

### CROSS-REFERENCE TO RELATED PATENT APPLICATION

This application claims the benefit of Korean Patent Application No. 10-2008-0018438, filed on Feb. 24, 2008, in the Korean Intellectual Property Office, the disclosure of which is incorporated herein in its entirety by reference.

### BACKGROUND OF THE INVENTION

1. Field of the Invention

The present invention relates to a method of securely distributing and acquiring a password of a radio frequency identification (RFID) tag.

2. Description of the Related Art

RFID tags attached to products have been widely used in logistics industries. Techniques have been developed to allow a purchaser to continuously use the RFID tag without removing it, and to provide mobile services using a mobile phone with the RFID tag attached.

Some RFID tags store data and correct the data using a password. The password can prevent the RFID tag from being accessed unlawfully. In other words, a user who does not have the password of the RFID tag does not have authority to write data to the RFID tag.

When the user wants to purchase a product with the RFID tag attached and then continuously use the tag, unlawful writing to the RFID tag by others can be prevented by using the password function of the RFID tag.

To prevent others from unlawfully writing to the RFID tag, the password of the RFID tag should be provided to the user when the user purchases the product with the RFID tag attached, or when the product is personalized. In addition, the password should be provided confidentially, and the user should be able to recognize whether the password has been revealed previously.

### SUMMARY OF THE INVENTION

The present invention provides an apparatus and method of protecting an RFID password in order to securely provide a user with the password for an RFID tag attached to the product without revealing it to others.

The present invention also provides an RFID tag access method which easily determines whether the password has been revealed, and access the RFID tag attached to the product using the RFID password.

According to an aspect of the present invention, there is provided an apparatus for protecting an RFID password, comprising: a recording medium on which the password for an RFID tag is printed; and a disposable shielding member that can be removed physically or chemically, formed on the surface of the recording medium to visually shield the password.

According to another aspect of the present invention, there is provided a method of protecting an RFID password, comprising: printing the password for an RFID tag on a printable recording medium; and forming a disposable shielding member that can be removed physically or chemically, on a surface of the recording medium to visually shield the password.

According to another aspect of the present invention, there is provided an RFID tag access method using a password, comprising: acquiring the password from the surface of a printable recording medium by physically or chemically removing a shielding member from the surface of the printable recording medium; and reading and writing information recorded on the RFID tag using the password.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram showing an apparatus for protecting an RFID password according to an embodiment of the present invention;

FIG. 2 is a flowchart showing a method of protecting the RFID password according to another embodiment of the present invention; and

FIG. 3 is a flowchart showing an RFID tag access method according to another embodiment of the present invention.

### DETAILED DESCRIPTION OF THE INVENTION

The present invention will now be described more fully with reference to the accompanying drawings, in which exemplary embodiments of the invention are shown.

An apparatus and method of protecting an RFID tag and an RFID tag access method will now be described with reference to the attached drawings.

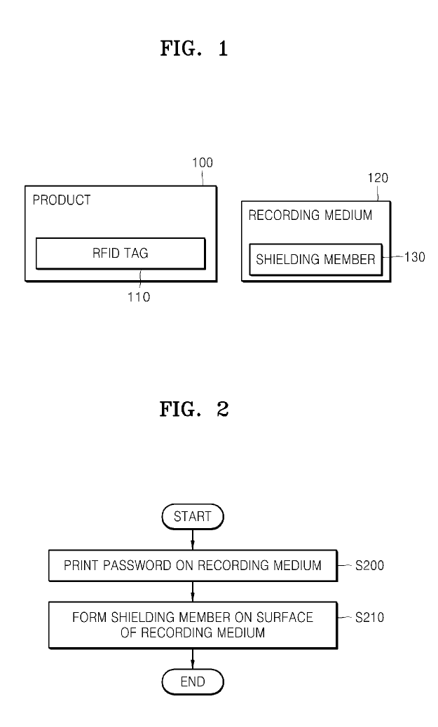

FIG. 1 is a diagram showing the apparatus for protecting the RFID password according to an embodiment of the present invention.

Referring to FIG. 1, the password together with the product 100 is provided to a user, so that the user can continuously use the personalized RFID tag 110 attached to the product 100. The password is printed on a recording medium 120 and provided to the user, so that the password may be protected and not revealed to others.

The password is printed on the printable recording medium 120 (for example, paper or plastic). Here, the printable recording medium 120 may be wrapping paper or wrapping box for wrapping the product with the RFID tag attached, the product with the RFID tag attached, or another printable recording medium. On the other hand, the printable recording medium may be attached to the product.

The password should be visually shielded so as not to be revealed to others before it is transferred to the user. Therefore, a disposable shielding member that can be removed physically or chemically is formed on the surface of the printable recording medium 120.

The disposable shielding member 130 can be physically or chemically removed from the surface of the printable recording medium 120 without damaging the password printed on the surface of the printable recording medium. For example, the shielding member 130 may be a silver film such as that formed on the surface of an instant lottery ticket. Alternatively, to prevent the password from being revealed, the shielding member 130 may be formed of a material such as paper, vinyl, or plastic and attached to the surface of the printable recording medium 120. In any case, the shielding member 130 should be disposable, so that the user can recognize the removal of the shielding member 130.

If the password is printed on the product 100 with the RFID tag attached, and the shielding member 130 is removed by the user, the password may be revealed to others. Therefore, in this case, the password needs to be removed from the product.

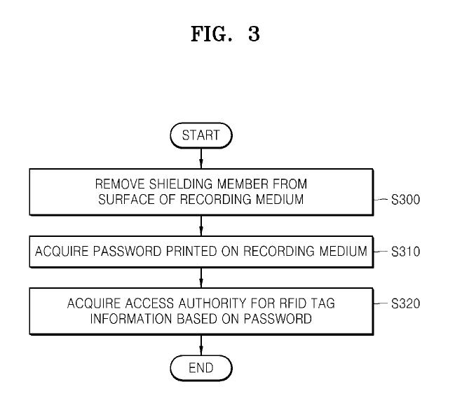

FIG. 2 is a flowchart showing a method of protecting the RFID password according to an embodiment of the present invention.

Referring to FIG. 2, the password for the RFID tag is printed on the printable recording medium, formed of a material such as paper or plastic (operation 200). In order to protect the password printed on the printable recording medium from being visually revealed, a shielding member is formed on the surface of the printable recording medium (operation 210).

The shielding member for protecting the password should be a disposable one, so that the user can recognize the removal of the shielding member easily. A representative shielding member may be a silver film such as that of an instant lottery ticket.

FIG. 3 is a flowchart showing an RFID tag access method according to another embodiment of the present invention.

Referring to FIG. 3, when the product with the RFID tag attached for purchasing and personalizing the product, and the printable recording medium with the password recorded and protected by a shielding member, are delivered to the user, the user checks whether or not the shielding member is damaged. If the shielding member is not damaged, the password printed on the printable recording medium is acquired by removing the shielding member from the surface of the printable recording medium (operations 300 and 310). For example, when a paint film such as a silver film is formed on the printable recording medium, the password printed on the printable recording medium can be acquired by removing the film with a coin or fingernail.

After the user inputs the password into the RFID reader, the user can read the RFID tag attached to the product using an RFID reader or record data onto the RFID tag (operation 320).

According to the present invention, a password for an RFID tag is provided for a user at the time that a product with the RFID tag attached is purchased or personalized, so that it is possible to prevent others from unlawfully writing data to the RFID tag. In addition, it can be easily determined whether or not the password has been revealed by checking for damage to the apparatus for protecting the password.

In addition, the present invention may be embodied by computer readable code in a computer readable recording medium. Computer readable recording media includes any types of recording devices for saving computer readable data. Computer readable recording media may be ROM, RAM, CD-ROMs, magnetic tape, floppy disks, optical or storage and the like, and also includes a carrier wave (for example, transmission through the internet). Alternatively, computer readable code may be saved and executed in such a manner that the computer readable recording medium may be distributed over computer systems connected by a network.

The preferred embodiments of the present invention have been described in detail. As those skilled in the art will appreciate, the invention may be modified in various ways without departing from the scope of the appended claims. Therefore, it is intended that the embodiments of the invention are provided not in a restrictive way but in an illustrative way. Therefore, the scope of the invention is defined not by the detailed description of the invention but by the appended claims, and all differences within the scope will be construed as being included in the present invention.

What is claimed is:

1. An apparatus for protecting an RFID password, comprising:
a recording medium on which the password for an RFID tag is printed; and
a disposable shielding member that can be removed physically or chemically, formed on a surface of the recording medium to visually shield the password.

2. The apparatus of claim 1, wherein the recording medium is paper or plastic on which the password is printed.

3. The apparatus of claim 1, wherein the shielding member is a paint film that can be removed from the surface of the recording medium by rubbing.

4. The apparatus of claim 1, wherein the recording medium is attached to a product to which the RFID is attached.

5. A method of protecting an RFID password, comprising:
printing the password for an RFID tag on a printable recording medium; and
forming a disposable shielding member that can be removed physically or chemically on a surface of the recording medium to visually shield the password.

6. The method of claim 5, wherein the forming of the shielding member comprises forming a paint film that can be removed by rubbing, on the surface of the recording medium.

7. An RFID tag access method using a password, comprising:
acquiring the password from a surface of a printable recording medium by physically or chemically removing a shielding member from the surface of the printable recording medium; and
reading and writing information on the RFID tag using the password.
